(19) United States
(12) Patent Application Publication
(10) Pub. No.: US 2006/0093844 A1
(43) Pub. Date: May 4, 2006

(54) Photochromic coating compositions, methods of making coated articles and articles thereof

(76) Inventors: Jeanine A. Conklin, Fishers, IN (US); Eric M. King, Pittsburgh, PA (US); Kevin J. Stewart, Murrysville, PA (US)

Correspondence Address: PPG Industries, Inc., 39th Floor, One PPG Place, Pittsburgh, PA, 15272-0001, US

(21) Appl. No.: 11/231,867

(22) Filed: Sep. 22, 2005

Related U.S. Application Data
(60) Provisional application No. 60/623,612, filed on Oct. 29, 2004.

(51) Int. Cl. B32B 27/30; B05D 5/06; G02B 5/00

(52) U.S. Cl. 428/500; 252/586; 427/162

(57) ABSTRACT

Described are ungelled coating compositions of photochromic material, precursor materials for a first polymer polymerizable by free-radical initiated polymerization and precursor materials for a second or additional polymer(s) different from the first polymer. When the second polymer is selected from polyurethane, poly(urea-urethane) and mixtures thereof, the precursor materials include at least one blocked polyisocyanate. Also described are methods of making photochromic articles using the ungelled coating compositions and the photochromic articles produced using these methods.

### CROSS REFERENCE TO RELATED APPLICATION

This application claims the benefit of U.S. provisional application Serial No. 60/623,612 filed Oct. 29, 2004.

### BACKGROUND OF THE INVENTION

The present invention is directed to photochromic coating compositions and methods of using such compositions to produce coated articles. The invention is also directed to the photochromic coated articles produced by the methods.

Polymerizable coating compositions containing photochromic materials as well as articles coated with these compositions are known. Although such products are known, it is desirable to have coating compositions in which the properties of the cured coating such as adhesion to a substrate and performance of the photochromic material can be better controlled. It is also desirable to have a method for producing photochromic coated articles that can be adapted for use in a non-factory setting, e.g., in an optical laboratory.

### DESCRIPTION OF THE INVENTION

The present invention includes various non-limiting embodiments. One such non-limiting embodiment is an ungelled coating composition comprising a photochromic material, precursor materials for a first polymer polymerizable by free-radical initiated polymerization and precursor materials for a second polymer selected from polyurethane, poly(urea-urethane) and mixtures thereof, the precursor materials for said second polymer comprising a blocked polyisocyanate.

In accordance with an alternate non-limiting embodiment of the present invention, an ungelled coating composition comprises a photochromic material, precursor materials for a first polymer polymerizable by free-radical initiated polymerization and precursor materials for one or more additional polymer(s) different from the first polymer, said ungelled coating composition being substantially free of polyurethanes and/or poly(urea-urethanes).

Another non-limiting embodiment provides a method for making a photochromic article comprising:

a) obtaining a substrate;

b) connecting to a surface of the substrate an at least partial coating of either of the aforementioned ungelled coating compositions; and

c) at least partially curing the coating of said ungelled coating composition.

A further non-limiting embodiment provides a method of making a photochromic coated lens in a non-factory setting comprising:

a) obtaining a lens coating apparatus;

b) obtaining a lens;

c) introducing said lens to the lens coating apparatus;

d) connecting to a surface of said lens an at least partial coating of either of the aforementioned ungelled coating compositions; and

e) at least partially curing the coating of said ungelled coating composition.

A still further non-limiting embodiment provides that the at least partial curing of the coating of the ungelled coating composition in the aforementioned methods is carried out such that an at least partial cure of the precursor materials for the second or additional polymer(s) is commenced prior to completion of cure of precursor materials for the first polymer. A yet further non-limiting embodiment provides a photochromic coated article produced by any of the aforementioned method.

As used in this specification and the appended claims, the singular forms “a,” “an,” and “the” include plural referents unless expressly and unequivocally limited to one referent. Although the invention is described in terms of “a” or “an” or “the”, the scope of the invention is not so limited and encompasses the use of more than “a” material, surface, etc., unless expressly and unequivocally limited to one.

For the purposes of this specification, unless otherwise indicated, all numbers expressing quantities of ingredients, reaction conditions, and other parameters used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

As used herein, “precursor materials”, includes monomers and polymers capable of being further polymerized and conventional materials used in the polymerization process, e.g., curing catalyst, initiator, co-initiator or donor material, e.g., a hydrogen donor material. A “monomer” is a single monomer unit. A “polymer” is a material formed by the union of two or more monomers. The term polymer includes without limitation both homopolymers and copolymers.

The term “ungelled” refers to a coating composition comprising precursor materials that are substantially free of crosslinking. The term “crosslinking” refers to the connection of two chains of polymer molecules by bridges composed of an element, group and/or a compound. A precursor material that is “substantially free of crosslinking” refers to a material that has a weight average molecular weight (Mw), as determined by gel permeation chromatography, of less than 1,000,000 and a measurable intrinsic viscosity when dissolved in a suitable solvent, as determined, for example, in accordance with ASTM-D2857. The intrinsic viscosity of the precursor material is an indication of its molecular weight. A crosslinked or gelled precursor material, on the other hand, will have an intrinsic viscosity not measurable by the ASTM test.

In one non-limiting embodiment of the ungelled coating composition, the precursor materials for the first polymer polymerizable by free-radical initiated polymerization may include a wide variety of precursor materials such as materials comprising ethylenically unsaturated groups. Non-limiting examples of such ethylenically unsaturated groups include allylic groups, methacrylic groups, acrylic groups, vinyl groups and mixtures thereof. In a further non-limiting embodiment, the precursor materials comprise methacrylic groups.

Non-limiting examples of precursor materials comprising allylic groups include polyol (allyl carbonate) monomers, e.g., ethylene glycol bis(allyl carbonate) and poly (allyl ester) monomers, e.g., diallyl isophthalate, and mixtures thereof. Such allyl functional monomers are described in U.S. Pat. No. 6,506,864 at column 1, line 11 to column 12, line 32, which disclosure of allyl functional monomers is incorporated herein by reference.

Non-limiting examples of precursor materials comprising (meth)acrylic groups, e.g., methacrylic and acrylic groups, includes alkyl esters of acrylic and methacrylic acids having from 4 to 17 carbon atoms in the alkyl group. Non-limiting examples of such (meth)acrylates, e.g. methacrylates and acrylates, may include butyl methacrylate, butyl acrylate, cyclohexyl methacrylate, cyclohexyl acrylate, 2-ethylhexyl methacrylate, 2-ethylhexyl acrylate, butyl hexylmethacrylate, butyl hexylacrylate, isooctylmethacrylate, isooctylacrylate, isodecyl methacrylate, isodecyl acrylate, isobornyl methacrylate, isobornyl acrylate, lauryl methacrylate and lauryl acrylate, and mixtures thereof. In one non-limiting embodiment, the aforementioned mono-functional (meth)acrylates may be used in combination with the polyfunctional precursor materials described hereinafter to produce a curable coating using the ungelled coating composition of the present invention, as known to those skilled in the art.

Other non-limiting examples of (meth)acrylates that may be used as precursor materials for the first polymer include difunctional (meth)acrylates, e.g., poly(ethylene glycol) dimethacrylate disclosed in U.S. Pat. No. 6,602,603 at column 3, line 51 to column 6, line 37 and the multi-functional (meth)acrylates e.g., pentaerythritol tri- and tetra(meth)acrylates, disclosed in U.S. Pat. No. 6,733,887 in column 5 lines 36 to 61, which disclosures of such (meth)acrylates are incorporated herein by reference.

Further non-limiting examples of monomers comprising methacrylic and acrylic groups include unsaturated organosilanes, e.g., (trimethoxysilyl)propyl (meth)acrylate, disclosed in U.S. Pat. No. 4,684,697 at column, 14, line 12 to line 41, which disclosure of unsaturated organosilanes is incorporated herein by reference.

Still further non-limiting examples of monomers comprising methacrylic and acrylic groups include polycarbonate based urethane containing monomers such as the reaction product of a polyol comprising a carbonate group, e.g., an aliphatic polycarbonate diol, and an isocyanate comprising one reactive isocyanate group and a polymerizable double bond, e.g., isocyanatoethylmethacrylate and m-isopropenyl-α, α-dimethyl benzyl isocyanates, and the co-polymerizable monomers disclosed in U.S. Patent Publication 2003/0143404 from paragraph [0012] to [0115], which disclosure of such monomers and copolymerizable monomers is incorporated herein by reference.

Non-limiting examples of vinyl group containing precursor materials for the first polymer, include vinyl aromatic monomers, e.g., styrene, α-methyl styrene, t-butyl styrene and vinyl toluene; vinyl and vinylidene halides, e.g., vinyl chloride and vinylidene chloride; vinyl esters, e.g., vinyl butyrates, and mixtures thereof.

In a further non-limiting embodiment of the ungelled coating composition, the precursor materials for the first polymer may include ethylenically unsaturated materials comprising other groups such as cyano, amino, hydroxyl, epoxy, amide and mixtures thereof. Non-limiting examples of such materials include: allylamine, dimethylallylamine, 2-(dimethylamino)ethyl methacrylate, 2-(t-butylamino)ethyl methacrylate, 4-aminostyrene, methacrylonitrile, N-(3-dimethylaminopropyl)methacrylamide, N-(butoxymethyl)methacrylamide, 2-hydroxyethyl methacrylate, 2-hydroxyethyl acrylate, 4-hydroxybutyl methacrylate, dicaprolactone acrylate, glycidyl acrylate, glycidyl methacrylate, methacrylamide, acrylamide and mixtures thereof.

Further non-limiting examples of precursor materials comprising ethylenically unsaturated groups include monomers having a blocked isocyanate group, such as 2--(O-[1′-methylpropylidene amino] carboxy amino) ethyl acrylate and 2-(O-[1′-methylpropylidene amino] carboxy amino) ethyl methacrylate. A commercial example of the methacrylate material is KARENZMOI®-BM from Showa Denko K.K., Japan. In the aforementioned monomers having a blocked isocyanate group, the blocking agent methylethylketone oxime may be replaced by other such blocking agents described hereinafter to unblock at various temperatures.

In one non-limiting embodiment of the ungelled coating composition, of the present invention the precursors for the first polymer may include an initiating amount of a polymerization initiator. The expression an “initiating amount” of initiator is an amount suitable to initiate the polymerization of the polymerizable precursor materials. All initiators described herein may be substituted with the latent forms of such materials to be used as appropriate to obtain a desired outcome of the polymerization reactions as known to those skilled in the art. The term “latent” meaning that the initiator is inactive such as by the use of a suitable blocking agent and can be converted into its active form by the application of energy such as light or heat.

A wide variety of initiators may be used, non-limiting examples of which include thermal initiators, photoinitiators and mixtures thereof. Such materials capable of generating free radicals, include organic peroxy compounds or azobis(organonitrile) compounds. The amounts of initiator used may vary according to the particular initiator used. With respect to azobis(organonitrile) compounds, in one non-limiting embodiment, between 0.01 and 5.0 parts of initiator per 100 parts of polymerizable precursor materials may be used. Non-limiting examples of thermal initiators and photoinitiators are disclosed in U.S. Pat. No. 6,602,603 at column 11, line 23 to column 13, line 36, which disclosure of such polymerization initiators is incorporated herein by reference.

In another non-limiting embodiment of the ungelled coating composition of the present invention, the precursor materials for the second polymer which is polyurethane, poly(urea-urethane) and mixtures thereof, are precursor materials comprising a blocked polyisocyanate. In a further non-limiting embodiment, the blocked polyisocyanate is essentially free of unblocked isocyanate groups.

The expression “blocked” polyisocyanate means that the free isocyanate groups of the polyisocyanate are reacted with blocking agents. Typically, an excess of blocking agent is used to react with the free isocyanate groups, but there may be some isocyanate groups that remain unblocked. In one non-limiting embodiment, the ungelled coating composition comprises a level of unblocked isocyanate groups in an amount that does not cause any significant degree of crosslinking in the coating composition. In another non-limiting embodiment, the ungelled coating composition is “essentially free” of unblocked isocyanate groups. The term “essentially free” means that the level of unblocked isocyanates groups is less than 1 percent of the total weight of blocked polyisocyanates, e.g., 0.5 percent or less or 0.2 percent or less.

In a still further non-limiting embodiment, the polyisocyanates used to prepare the blocked polyisocyanate precursor materials for the second polymer, may be any known polyisocyanates having two or more isocyanates per molecule. Non-limiting examples of blocked polyisocyanates may be aliphatic polyisocyanates, aromatic polyisocyanates, cycloaliphatic polyisocyanates, heterocyclic polyisocyanates, derivatives thereof and mixtures thereof. Non-limiting examples of polyisocyanates are disclosed in U.S. Pat. Nos. 6,187,444 at column 5, line 38 to column 6, line 22 and in 6,531,076 at column 5, line 31 to column 7 line 30, which disclosures of polyisocyanates are incorporated herein by reference.

The term “derivatives thereof” referring to polyisocyanates means that from some to all of the isocyanate groups of the polyisocyanate are chemically modified to introduce chemical groups such as biuret, urea, carbodiimide, urethane and isocyanurate groups or by cycloaddition processes to yield dimers, trimers etc. of the isocyanates, as known to those skilled in the art.

Further non-limiting examples of polyisocyanates that may be used to prepare the precursor materials for the second polymer comprising a blocked polyisocyanate are aliphatic polyisocyanates including: tetramethylene-1,4-diisocyanate; hexamethylene-1,6-diisocyanate; 2,2,4-trimethyl hexane-1,6-diisocyanate; lysine methyl ester diisocyanate; bis (isocyanato ethyl)fumarate; ethylene diisocyanate; dodecane-1,12-diisocyanate; derivatives thereof and mixtures thereof; aromatic polyisocyanates including: toluene-2,4-diisocyanate; toluene-2,6-diisocyanate; diphenyl methane -4,4′-diisocyanate; diphenyl methane-2,4′-diisocyanate; para-phenylene diisocyanate; biphenyl diisocyanate; 3,3′-dimethyl4,4′-diphenylene diisocyanate; derivatives thereof and mixtures thereof; cycloaliphatic polyisocyanates including: isophorone diisocyanate; cyclobutane-1,3-diisocyanate; cyclohexane-1-3-diisocyanate; cyclohexane-1,4-diisocyanate; methyl cyclohexyl diisocyanate; perhydrodiphenylmethane-2,4′-diisocyanate; perhydrodiphenylmethane-4,4′-diisocyanate, derivatives thereof and mixtures thereof.

In a further non-limiting embodiment, blocked mono-isocyanate containing materials may be included with the blocked polyisocyanates in the formation of the polyurethane and poly (urea-urethane) polymers. Non-limiting examples of mono-isocyanate containing materials include: aliphatic isocyanates such as isopropylisocyanate, n-butylisocyanate and stearylisocyanate; cycloaliphatic isocyanates such as cyclohexyl-isocyanate, and aromatic isocyanates such as p-tolylisocyanate, 4-isopropylphenyl-isocyanate and phenylisocyanate.

The blocking agents used to prepare the blocked polyisocyanate precursor material for the second polymer may include a wide variety of organic compounds having active hydrogen atoms known to those skilled in the art. Non-limiting examples include volatile alcohols, epsilon-caprolactam, azole-containing materials, ketoxime compounds and mixtures thereof. Non-limiting examples of such blocking materials may include methanol, diisopropyl amine, epsilon-caprolactam, 1,2,4-triazole, 3,5-dimethyl pyrazole, methyl ethyl ketoxime, and mixtures thereof.

In a further non-limiting embodiment of the ungelled coating composition, when the second polymer is polyurethane, in addition to blocked polyisocyanate, the precursor materials further comprise a polyol and when the second polymer is poly(urea-urethane), the precursor materials further comprise a polyamine and a polyol. Non-limiting examples of polyols suitable for use in the preparation of the polyurethane or poly(urea-urethane) include organic polyols having 2 or more hydroxyl groups per molecule and may include (a) low molecular weight polyols, e.g., polyols having a weight average molecular weight less than 500, e.g., aliphatic diols, such as C₂-C₁₀ aliphatic diols, triols, polyhydric alcohols and alkoxylated low molecular weight polyols; (b) polyester polyols; (c) polyether polyols; (d) amide-containing polyols; (e) polyacrylic polyols; (f) epoxy polyols; (g) polyhydric polyvinyl alcohols; (h) urethane polyols; (i) polycarbonate polyols or (j) mixtures thereof.

Preparation of all such polyols is well known and well understood by those skilled in the art. Non-limiting examples of such well known methods are described in the following sources: for polycarbonate polyols, U.S. Pat. Nos. 5,143,997 at column 3, line 43 to column 6, line 25, and 5,527,879 at column 2, line 10 to column 3, line 48 and for the other polyols, U.S. Pat. No. 6,187,444 at column 7, line 25 to column 12, line 15. The aforementioned disclosures of polyols are incorporated herein by reference.

Non-limiting examples of polyamine precursors used in the formation of a poly(urea-urethane) polymer may include materials having 2 or more amino groups per molecule. In one non-limiting embodiment, each amino group may be independently selected from primary amino (—NH₂) and/or secondary amino (—NH—). In one non-limiting embodiment, all of the amino groups may be primary amino. In another non-limiting embodiment, the polyamine reactant may be an aliphatic polyamine, cycloaliphatic polyamine, aromatic polyamine, polyamine of mixed aliphatic, cycloaliphatic, and/or aromatic types, or mixtures thereof. In a further non-limiting embodiment, the polyamine may comprise an aliphatic polyamine, aromatic polyamine and mixtures thereof. Non-limiting examples of aliphatic polyamines may include 1,2-ethanediamine, 1,6-hexanediamine, diethylene triamine and mixtures thereof. Non-limiting examples of aromatic polyamines may include 3,5-diethyl-2,4-toluenediamine, 3,5-diethyl-2,6-toluenediamine and mixtures thereof. Further non-limiting examples of polyamines include the materials disclosed in U.S. Pat. No. 6,531,076 at column 7, line 41 to column 8, line 29.

In one non-limiting embodiment, when the precursor materials are combined to form the second polymer, the relative amounts of the precursor materials are typically expressed as a ratio of the available number of reactive isocyanate groups (NCO) upon deblocking of the blocked polyisocanate to the available number of hydroxyl groups (OH) or hydroxyl (OH) and amino groups (NH).

In a further non-limiting embodiment, when the second polymer is polyurethane, the equivalent ratio of deblocked NCO:OH may range from 0.3:1.0 to 3.0:1.0, e.g., from 0.8:1.0 to 2.5:1 or from 1.0:1.0 to 1.5:1.0.

In a still further non-limiting embodiment, when the second polymer is a poly(urea-urethane) the number of equivalents of NCO upon deblocking of blocked polyisocyanates may be greater than the number of equivalents of OH and the number of equivalents of NH may be greater than or less than the remaining equivalents of deblocked NCO after subtracting the OH equivalents. For example, in one non-limiting embodiment, the equivalents of deblocked NCO may range from 1.3 to 4.5; the equivalents of OH may range from 1.0 to 1.2; and the equivalents of NH may range from 0.2 to 3.5.

In a further non-limiting embodiment, the precursor materials for the polyurethane and/or poly(urea-urethane) may comprise an optional catalyst. In a still further non-limiting embodiment, when the optional catalyst is present, non-limiting examples include tin octylate, dibutyltin diacetate, dibutyltin dilaurate, dibutyltin mercaptide, dibutyltin dimaleate, dimethyltin diacetate, dimethyltin dilaurate, dimethyltin mercaptide, dimethyltin dimaleate, triphenyltin acetate, triphenyltin hydroxide, 1,4-diazabicyclo[2.2.2]octane, triethylamine, bismuth carboxylate and mixtures thereof. Other non-limiting embodiments of catalysts are disclosed in U.S. Pat. Nos. 6,187,444 at column 6 lines 23 to 37 and in 6,531,076 at column 9, lines 30 to 41, which disclosures of catalysts are incorporated herein by reference.

A wide variety of photochromic materials well known to those skilled in the art may be used in the ungelled coating compositions of the present invention. In one non-limiting embodiment, the photochromic material may be an inorganic photochromic material, an organic photochromic material or mixtures thereof.

In alternate non-limiting embodiments, the photochromic materials described hereinafter may be provided in a variety of different forms. Non-limiting examples include: a single photochromic compound; a mixture of photochromic compounds; a material comprising a photochromic compound, such as a monomeric or polymeric ungelled solution; a material such as a monomer or polymer to which a photochromic compound is chemically bonded; a material comprising and/or having chemically bonded to it a photochromic compound, the outer surface of the material being encapsulated (encapsulation is a form of coating), for example with a polymeric resin or a protective coating such as a metal oxide that prevents contact of the photochromic material with external materials such as oxygen, moisture and/or chemicals that have a negative effect on the photochromic material, such materials can be formed into a particulate prior to applying the protective coating as described in U.S. Pat. Nos. 4,166,043 and 4,367,170; a photochromic polymer, e.g., a photochromic polymer comprising photochromic compounds bonded together; or mixtures thereof.

In one non-limiting embodiment, the photochromic material is inorganic and may contain crystallites of silver halide, cadmium halide and/or copper halide. Other non-limiting inorganic photochromic materials may be prepared by the addition of europium (II) and/or cerium (III) to a mineral glass such as a soda-silica glass. In one non-limiting embodiment, the inorganic photochromic materials may be added to molten glass and formed into particles that are incorporated into the coating composition. Such inorganic photochromic materials are described in Kirk Othmer Encyclopedia of Chemical Technology, 4th Edition, Volume 6, pages 322-325, which disclosure of inorganic photochromics is incorporated herein by reference.

In another non-limiting embodiment, the photochromic material may be an organic photochromic material comprising an activated absorption maxima in the range from 300 to 1000 nanometers. In a further non-limiting embodiment, the organic photochromic material may comprise a mixture of (a) an organic photochromic material having a visible lambda max of from 400 to less than 550 nanometers, and (b) an organic photochromic material having a visible lambda max of from 550 to 700 nanometers.

In a further non-limiting embodiment, the photochromic material is an organic photochromic material that may be a pyran, oxazine, fulgide, fulgimide, diarylethene or mixtures thereof.

Non-limiting examples of photochromic pyrans that can be used herein include benzopyrans, and naphthopyrans, e.g., naphtho[1,2-b]pyrans, naphtho[2,1-b]pyrans, indeno-fused naphthopyrans and heterocyclic-fused naphthopyrans, spiro-9-fluoreno[1,2-b]pyrans, phenanthropyrans, quinolinopyrans; fluoroanthenopyrans and spiropyrans, e.g., spiro(benzindoline)naphthopyrans, spiro(indoline)benzopyrans, spiro(indoline)naphthopyrans, spiro(indoline)quinolinopyrans and spiro(indoline)pyrans and mixtures thereof. Non-limiting examples of benzopyrans and naphthopyrans are disclosed in U.S. Pat. No. 5,645,767 at column 2, line 16 to column 12, line 57; U.S. Pat. No. 5,723,072 at column 2, line 27 to column 15, line 55; U.S. Pat. No. 5,698,141 at column 2, line 11 to column 19, line 45; U.S. Pat. No. 6,153,126 at column 2, line 26 to column 8, line 60; U.S. Pat. No. 6,022,497 at column 2, line 21 to column 11, line 46; U.S. Pat. No. 6,080,338 at column 2, line 21 to column 14, line 43; U.S. Pat. No. 6,136,968 at column 2, line 43 to column 20, line 67; U.S. Pat. No. 6,296,785 at column 2, line 47 to column 31, line 5; U.S. Pat. No. 6,348,604 at column 3, line 26 to column 17, line 15; U.S. Pat. No. 6,353,102 at column 1, line 62 to column 11, line 64; U.S. Pat. No. 6,630,597 at column 2, line 16 to column 16, line 23; and U.S. Pat. No. 6,736,998 at column 2, line 53 to column 19, line 7 which disclosures are incorporated herein by reference, More non-limiting examples of naphthopyrans and complementary organic photochromic substances are described in U.S. Pat. No. 5,658,501 at column 1, line 64 to column 13, line 17, which disclosure is incorporated herein by reference. Spiro(indoline)pyrans are also described in the text, Techniques in Chemistry, Volume III, “Photochromism”, Chapter 3, Glenn H. Brown, Editor, John Wiley and Sons, Inc., New York, 1971, which is also incorporated herein by reference.

Non-limiting examples of photochromic oxazines that can be used in conjunction with various non-limiting embodiments disclosed herein include benzoxazines, naphthoxazines, and spiro-oxazines, e.g., spiro(indoline)naphthoxazines, spiro(indoline)pyridobenzoxazines, spiro(benzindoline)pyridobenzoxazines, spiro(benzindoline)naphthoxazines, spiro(indoline)benzoxazines, spiro(indoline)fluoranthenoxazine, spiro(indoline)quinoxazine and mixtures thereof.

Non-limiting examples of photochromic fulgides or fulgimides that can be used in conjunction with various non-limiting embodiments disclosed herein include: fulgides and fulgimides, which are disclosed in U.S. Pat. No. 4,685,783 at column 1, line 57 to column 5, line 27, and in U.S. Pat. No. 4,931,220 at column 1, line 39 through column 22, line 41, the disclosure of such fulgides and fulgimides are incorporated herein by reference. Non-limiting examples of diarylethenes are disclosed in U.S. Patent Application 2003/0174560 paragraphs [0025] to [0086] which disclosure related to diarylethenes is incorporated herein by reference.

According to one non-limiting embodiment, the photochromic materials are present during the at least partial curing of the precursor materials of the ungelled coating composition. In another non-limiting embodiment, the photochromic materials are present during the at least partial curing of the precursor materials for the first polymer polymerized by free-radical polymerization. In a further non-limiting embodiment, the photochromic material is an organic photochromic adapted to polymerize with the precursor materials of the ungelled coating composition. In another non-limiting embodiment, the use of polymerizable groups as substituents on the organic photochromic compounds, as known to one skilled in the art, may be employed to react with the precursor materials of the first polymer and/or the other polymer(s) different from the first polymer. Non-limiting examples of such polymerizable groups include methacryloyloxy, acryloyloxy, vinyl, allyl, carboxyl, amino, mercapto, epoxy, hydroxy, isocyanato and mixtures thereof.

Non-limiting example of polymerizable photochromic materials, include polymerizable naphthoxazines disclosed in U.S. Pat. No. 5,166,345 at column 3, line 36 to column 14, line 3; polymerizable spirobenzopyrans disclosed in U.S. Pat. No. 5,236,958 at column 1, line 45 to column 6, line 65; polymerizable spirobenzopyrans and spirobenzothiopyrans disclosed in U.S. Pat. No. 5,252,742 at column 1, line 45 to column 6, line 65; polymerizable fulgides disclosed in U.S. Pat. No. 5,359,085 at column 5, line 25 to column 19, line 55; polymerizable naphthacenediones disclosed in U.S. Pat. No. 5,488,119 at column 1, line 29 to column 7, line 65; polymerizable spirooxazines disclosed in U.S. Pat. No. 5,821,287 at column 3, line 5 to column 11, line 39; polymerizable polyalkoxylated naphthopyrans disclosed in U.S. Pat. No. 6,113,814 at column 2, line 23 to column 23, line 29; and the polymerizable photochromic materials disclosed in U.S. Pat. No. 6,555,028 at column 2, line 40 to column 31, line 64. The disclosures of the aforementioned patents on polymerizable photochromic materials are incorporated herein by reference.

The photochromic materials to be used may be associated with the ungelled coating composition, by various means. In a series of non-limiting embodiments, the photochromic materials can be incorporated, e.g., dissolved and/or dispersed, into the precursor materials and/or polymerized with the precursor materials. If desired, additional amounts of photochromic materials can be incorporated into the at least partially cured photochromic coating, in one non-limiting embodiment, individually or in combination with adjuvants such as kinetic enhancing materials, stabilizers, etc., by imbibition, permeation or other transfer methods, as known by those skilled in the art.

In another non-limiting embodiment, the amount of the photochromic materials to be incorporated into the ungelled coating composition can vary widely. Typically, a sufficient amount is used to produce a photochromic effect discernible to the naked eye upon activation. Generally, such amount can be described as a photochromic amount. The particular amount used depends often upon the intensity of color desired upon irradiation thereof and upon the method used to incorporate the photochromic materials. Typically, in one non-limiting embodiment, the more photochromic incorporated, the greater is the color intensity up to a certain limit. There is a point after which the addition of any more material will not have a noticeable effect, although more material can be added, if desired.

In a further non-limiting embodiment, the total amount of photochromic material included with the precursor materials of the ungelled composition used to form a coating can vary widely. In one non-limiting embodiment, the amount ranges from 0.01 to 40 weight percent based on the weight of the total solids in the coating composition. In alternate non-limiting embodiments, the concentration of photochromic materials may range from 0.1 to 30 weight percent, from 1 to 20 weight percent, from 5 to 15 weight percent, or from 7 to 14 weight percent.

In another non-limiting embodiment, adjuvant materials may also be incorporated into the ungelled coating composition, e.g., conventional ingredients that aid in processing or impart desired characteristics to the resulting cured coating. Non-limiting examples of such ingredients may include rheology control agents, surfactants, cure-inhibiting agents, reducing agents, acids, bases, preservatives, plasticizers, crosslinking materials, free radical donors, free radical scavengers, stabilizers such as ultraviolet and thermal stabilizers, and adhesion promoting agents, such as organofunctional silanes, siloxanes, titanates and zirconates, which adjuvant materials are known to those skilled in the art.

In accordance with an alternate non-limiting embodiment of the present invention, the ungelled coating composition may comprise the aforementioned photochromic material, the aforementioned precursors for a first polymer polymerizable by free radical initiated polymerization and precursor materials for one or more additional polymer(s) different from the first polymer, i.e., polymerized by a method other than free radical initiation, provided that said ungelled coating composition is substantially free of polyurethanes and/or poly(urea-urethanes). In another non-limiting embodiment, the ungelled coating composition is essentially free of polyisocyanates. In a further non-limiting embodiment, a catalytic amount of catalyst may be used with the precursor materials for the additional polymer.

The expression a “catalytic amount” of catalyst is an amount suitable to catalyze the curing or polymerization of the curable precursor materials. All catalysts described herein may be substituted with the latent form, i.e., a form of the catalyst that is inactive such as by the use of a suitable blocking agent and that can be made active by the application of energy such as light or heat, of such materials to be used as appropriate to obtain a desired outcome of the curing reactions as known to those skilled in the art. Non-limiting examples of latent catalysts include latent acid catalysts which can be formed by preparing an amine salt of the acid catalyst which may be activated by heating during the cure; and an example of an latent base catalyst is aminoacetophenone which releases amine upon photo-activation. In a further non-limiting embodiment, the latent catalyst may include acid catalysts, basic catalysts, cationic catalysts and mixtures thereof. Further non-limiting examples of catalysts and latent catalysts are disclosed hereinafter.

In one non-limiting embodiment of the ungelled coating composition of the present invention, the additional polymer(s) to be formed from precursor materials may be polyepoxide; polyoxetane; aminoplast-containing polymer; tris(alkoxycarbonylamino)triazine-containing polymer; polyanhydride-containing polymer; polyacrylamide-containing polymer; polyether; (meth)acrylic addition interpolymer; organopolysiloxane; or a mixture thereof.

In the following non-limiting embodiments of the precursor materials for the additional polymer(s), materials having ethylenically unsaturated groups reactive in a free radical initiated process, in one non-limiting embodiment, are typically prereacted to produce polymeric precursor materials having a chemical group reactive in polymerization processes other than free radically initiated processes, e.g., polymerization by condensation.

In one non-limiting embodiment of the ungelled coating composition, the additional polymer(s) to be formed from the precursor materials may be any polyepoxide known to those skilled in the art. In another non-limiting embodiment, the precursor materials for the polyepoxide may include epoxy-group containing materials that are capable of being polymerized by means well known in the art to form a polyepoxide. In a further non-limiting embodiment, a polyacid curing agent, known to those skilled in the art, may be included as a precursor material. In a still further non-limiting embodiment, a catalytic amount of an epoxy curing catalyst may be utilized.

Non-limiting examples of epoxy group containing materials that may be used as precursor materials include resorcinol diglycidylether, trimethylolpropane triglycidylether, bis-(3,4-epoxycyclohexylmethyl)adipate, epoxy-containing acrylic polymers, epoxy condensation polymers such as polyglycidyl ethers of alcohols and phenols and polyglycidyl esters of polycarboxylic acids, polyepoxide monomers and mixtures of such polyepoxides. Non-limiting examples of these materials are described in U.S. Pat. No. 6,268,055 column 4, line 18 to column 6, line 56, which disclosure of polyepoxides is incorporated herein by reference.

Non-limiting examples of polyacid curing agents include carboxylic acid group-containing polymers such as acrylic polymers and polyesters, and half-esters formed by reacting polyols and cyclic 1,2-acid anhydrides. Catalysts used to accelerate the reaction of the carboxyl group and the epoxy group, in one non-limiting embodiment, may also be present. Non-limiting examples of polyacid curing agents and catalysts are disclosed in U.S. Pat. No. 6,268,055 at column 6, line 57 to column 15, line 12, which disclosure on polyacid curing agents and catalysts is incorporated herein by reference. See also Werner J. Blank, et al., “Catalysis of the Epoxy-Carboxyl Reaction” presented at the International Waterborne, High-Solids and Powder Coatings Symposium Feb. 21-23, 2001.

In one non-limiting embodiment, catalysts for the epoxy group containing precursor material include a wide variety of acidic and basic catalysts known to those skilled in the art. Non-limiting examples may include a Lewis acid; a Bronsted acid, and a basic catalyst, such as secondary amine catalysts, e.g. piperidine; tertiary amine catalysts, e.g., N,N-dimethyldodecylamine; ammonium compounds, e.g., tetrabutylammonium hydroxide; phosphonium compounds, e.g., ethyltriphenylphosphonium acetate; and salts of other ammonium and phosphonium compounds.

Further catalysts for the epoxy group containing precursor material include a cationic catalyst such as disclosed in U.S. Pat. No. 6,743,510 at column 8, line 55 to column 9, line 39 and/or a latent cationic catalyst such as disclosed in U.S. Pat. No. 6,306,555 at column 1, line 5 to column 7, line 6, which disclosures related to cationic and latent cationic catalysts are incorporated herein by reference.

In another non-limiting embodiment of the ungelled coating composition of the present invention, the additional polymer(s) to be formed from precursor materials may be any polyoxetane known to those skilled in the art. In a further non-limiting embodiment, the precursor materials for the polyoxetane may include oxetane-group containing materials that are capable of being polymerized by means well known in the art to form a polyoxetane. In another non-limiting embodiment, a catalytic amount of an oxetane catalyst may be utilized.

Non-limiting examples of the precursor materials for the polyoxetanes are oxetane group containing materials that react in a similar manner as epoxy group containing materials. Non-limiting examples of oxetanes include 3-ethyl-3-hydroxymethyloxetane, 3-ethyl-3-[(2-ethylhexyloxy) methyl] oxetane, bis {[1-ethyl(3-oxetanil)]methyl}ether, 3-ethyl-[(tri-ethoxysilylpropoxy)methyl]oxetane and oxetanyl-silsesquioxane. Further examples of oxetanes are included in U.S. Pat. No. 6,743,510 at column 2, line 16 to column 3, line 18, which examples of oxetanes are incorporated herein by reference. The aforementioned curing agents and catalysts for the epoxy group containing materials may be used with the oxetane group containing materials.

In another non-limiting embodiment of the ungelled coating composition, the additional polymer(s) to be formed from precursor materials may be any aminoplast-containing polymer, tris(alkoxycarbonylamino)triazine (TACT)-containing polymer or mixture thereof known to those skilled in the art. In a further non-limiting embodiment, the precursor materials for these polymers may include an aminoplast resin having at least two reactive groups and/or a TACT resin and a different material having at least two groups that are reactive with aminoplast and/or TACT resins. Suitable precursor materials may have a wide variety of groups that are reactive with aminoplast and/or a TACT resins. Non-limiting examples of such reactive group(s) include carboxyl, hydroxyl, carbamate, urea and mixtures thereof.

In a further non-limiting embodiment, the aminoplast resins used as precursor materials in forming the aminoplast-containing polymers may include condensation products of amine or amides with aldehydes, such as methylated melamine formaldehyde resins, butylated melamine formaldehyde resins, methylated urea formaldehyde resins, butylated urea formaldehyde resins, methylated benzoguanamine formaldehyde resins, butylated benzoguanamine formaldehyde resins, alkylated glycouril formaldehyde resins and mixtures thereof. Non-limiting examples of tris(alkoxycarbonylamino)triazine resins that may be used as precursor materials are disclosed U.S. Pat. No. 6,146,707 at column 2, line 48 to column 3, line 6, which disclosure is incorporated herein by reference. Another non-limiting example of a TACT resin for use as a precursor material is CYLINK® 2000 crosslinking agent, which is available from CYTEC Industries, Inc.

In a still further non-limiting embodiment, precursor materials having at least two groups that are reactive with aminoplast and/or a TACT resins in forming the aminoplast-containing polymers include the aforementioned polyols, carboxyl group containing materials, hydroxyl group containing polymers, carbamate group containing polymers, urea group containing polymers and mixtures thereof disclosed in U.S. Pat. No. 6,432,544 column 1, line 34 to column 12, line 22, which disclosure of precursor materials having at least two groups that are reactive with aminoplast and/or a TACT resins is incorporated herein by reference.

In yet a further non-limiting embodiment, the precursor materials may include a catalytic amount of catalyst for accelerating the curing reaction of the aminoplast and/or a TACT resins with the material having reactive groups described above. A wide variety of acidic catalysts disclosed herein may be used.

In another non-limiting embodiment of the ungelled coating composition of the present invention, the additional polymer(s) to be formed from precursor materials may be any of a variety of polyanhydride-containing polymers, known to those skilled in the art. In a further non-limiting embodiment, the precursor materials for the polyanhydride-containing polymers may include polymeric materials having at least two cyclic carboxylic acid anhydride groups and hydroxyl-functional component(s) having at least two hydroxyl groups as described in U.S. Pat. No. 6,436,525 at column 2, line 15 to column 11, line 60, which disclosure of such precursor materials is incorporated herein by reference. Further non-limiting examples of hydroxyl-functional components, anhydride-functional component(s) and other components that can be used to prepare the polyanhydride-containing polymers are disclosed in U.S. Pat. Nos. 4,798,745 at column 2, line 67 to column 9, line 8 and 5,239,012 at column 4, line 1 to column 5, line 62.

In another non-limiting embodiment of the ungelled coating composition of the present invention, the additional polymer(s) to be formed from precursor materials may be any of a variety of polyacrylamide-containing polymers, known to those skilled in the art. In one non-limiting embodiment, the precursor materials include acrylamide functional materials, e.g., polymers such as the free radical initiated reaction product of a polymerizable ethylenically unsaturated composition comprising: a) from 25 to 80% by weight of an N-alkoxymethyl(meth)acrylamide; and b) from 20 to 75% by weight of another copolymerizable ethylenically unsaturated monomer, said weight percentages being based on the total weight of the polymerizable ethylenically unsaturated monomers as described in U.S. Pat. No. 6,060,001 at column 2, line 6, to column 4, line 51, which disclosure of such acrylamide functional reaction products and polyacrylamides is incorporated herein by reference. Methods for preparing the precursor materials such as N-alkoxymethyl(meth)acrylamide functional polymers are described in U.S. Pat. No. 5,618,586 at column 2, line 48 to column 5, line 29. In one non-limiting embodiment, the term N-alkoxymethyl(meth)acrylamide means either N-alkoxymethylacrylamide or N-alkoxymethylmethacrylamide.

In a further non-limiting embodiment, the copolymerizable ethylenically unsaturated monomers without alkoxyacrylamide functionality used with the N-alkoxymethyl(meth)acrylamide to form the acrylamide functional precursor materials may include any of the aforementioned ethylenically unsaturated monomers discussed earlier in the specification and other such monomers known to those skilled in the art.

In another non-limiting embodiment, the precursor materials for the polyacrylamide-containing material may include a catalytic amount of a catalyst to accelerate cure. A wide variety of acidic catalysts may be used including latent catalysts such as ionic and covalently blocked acid catalysts, e.g., amine blocked alkyl acid phosphate or morpholine p-toluene sulfonic acid salt and cyclohexylarenesulfonic acids. See U.S. Pat. No. 4,454,274 at column 2, line 59 to column 5, line 23, which disclosure of latent catalysts is incorporated herein by reference.

In another non-limiting embodiment of the ungelled coating composition of the present invention, the additional polymer(s) to be formed from precursor materials may be any polyether, known to those skilled in the art. In one non-limiting embodiment, precursor materials of polyethers may include tris[4-vinyloxy)butyl] trimellitate, bis[4-vinyloxymethyl)cyclohexylmethyl]glutarate, bis[4-vinyloxybutyl]succinate, and bis[4-vinyloxybutyl]adipate. Other non-limiting examples of precursors for polyethers include: glycidyl vinyl ether and glycidyl vinylbenzyl ether.

A wide variety of catalysts may be used to prepare the polyethers as known to those skilled in the art. Non-limiting examples of suitable catalysts include cationic photoinitiators such as triarylsulfonium salts, which are commercially available as SAR CAT® CD-1011 and CD-1012 from Sartomer Co., and onium salts described in U.S. Pat. No. 5,639,802, column 8, line 59 to column 10, line 46, which disclosure is incorporated herein by reference. Non-limiting examples of such initiators include 4,4′-dimethyldiphenyliodonium tetrafluoroborate, phenyl-4-octyloxyphenyl phenyliodonium hexafluoroantimonate, dodecyldiphenyl iodonium hexafluoroantimonate, [4-[(2-tetradecanol)oxy]phenyl]phenyl iodonium hexafluoroantimonate and mixtures thereof. Non-limiting examples of latent cationic catalysts include p-methoxybenzylanilinium hexafluoroantimonate, cyclohexylarene sulfonates, phosphonium ylids, and (triphenylphosphinemethylene)-boranes.

In a further non-limiting embodiment of the ungelled coating composition of the present invention, the additional polymer(s) to be formed from precursor materials may be any (meth)acrylic addition interpolymer comprising a silicon atom bonded to a hydrolysable group, known to those skilled in the art. In one non-limiting embodiment, the (meth)acrylic addition interpolymer may be prepared by reacting a hydroxyl functional (meth)acrylic polymer with an organosilicon-containing material as described in U.S. Pat. No. 4,684,697 at column 15, line 26 to column 22, line 68, the disclosure of such (meth)acrylic addition interpolymers and methods of preparation is incorporated herein by reference.

In a further non-limiting embodiment of the ungelled coating composition of the present invention, the additional polymer(s) to be formed from precursor materials may be any organopolysiloxanes, known to those skilled in the art. In one non-limiting embodiment, the precursor materials for the organopolysiloxanes may be the hydrosilylation reaction product of polysiloxanes containing silicon hydride and a functional group containing material having an unsaturated bond capable of undergoing the hydrosilylation reaction. Non-limiting examples of functional groups include hydroxyl, carboxyl, isocyanates and blocked isocyanates, primary amines, secondary amines, amides, carbamates, urea, urethane, alkoxysilane, vinyl and epoxy. Non-limiting examples of such organo-functional polysiloxanes and methods for preparation are disclosed in U.S. Pat. No. 6,387,997 at column 7, line 22 to column 8, line 27, which disclosure of organo-functional polysiloxanes and preparation thereof is incorporated herein by reference.

In one non-limiting embodiment, the ungelled coating composition of the present invention may comprise along with the precursor material mentioned herein a preformed polymer which may or may not have reactive functional groups, as desired, as long as the coating composition remains ungelled. As previously mentioned, adjuvant materials may also be included in the ungelled coating composition of the present invention.

The aforementioned ungelled coating compositions may be used in a wide variety of applications. In one non-limiting embodiment, the ungelled coating compositions may be used as paints, e.g., a pigmented liquid or paste used for the decoration, protection and/or the identification of a substrate; inks, e.g., a pigmented liquid or paste used for writing and printing on substrates such as in producing verification marks on security documents, e.g., in security applications for documents such as banknotes, passports, drivers' licenses, identification cards, product labels and credit cards, for which authentication or verification of authenticity may be desired; and optical coatings used as described hereinafter.

Non-limiting examples of substrates for the ungelled coating compositions of the present invention include substrates of any type such as, paper, glass, ceramics, wood, masonry, textiles, metals and polymeric organic materials. In one non-limiting embodiment, the substrate may be an polymeric organic material, such as thermoplastic and thermoset polymeric organic materials, e.g., thermoplastic polycarbonate type polymers and copolymers and thermosetting homopolymers or copolymers of a polyol(allyl carbonate) used as organic optical materials.

Non-limiting examples of the aforementioned polymeric organic materials that can be used as substrates in conjunction with various non-limiting embodiments disclosed herein include polymeric materials, for example, homopolymers and copolymers, prepared from the monomers and mixtures of monomers disclosed in U.S. Pat. No. 6,733,887 at column 9, line 55 to column 17, line 7 and in U.S. Pat. No. 5,658,501 from column 15, line 28 to column 16, line 17, the disclosures of which U.S. patents are incorporated herein by reference.

Non-limiting examples of such disclosed monomers and polymers include: polyol(allyl carbonate) monomers, e.g., allyl diglycol carbonates such as diethylene glycol bis(allyl carbonate), which monomer is sold under the trademark CR-39 by PPG Industries, Inc, and copolymers thereof; poly(urea-urethane) polymers, which are prepared, for example, by the reaction of a polyurethane prepolymer and a diamine curing agent, a composition for one such polymer being sold under the trademark TRIVEX by PPG Industries, Inc; acrylic functional monomers, such as but not limited to, polyol(meth)acryloyl terminated carbonate monomers; diethylene glycol dimethacrylate monomer; ethoxylated phenol methacrylate-monomers; diisopropenyl benzene monomer; ethoxylated trimethylol propane triacrylate monomers; ethylene glycol bismethacrylate monomer; poly(ethylene glycol) bismethacrylate monomers; urethane acrylate monomers; poly(ethoxylated bisphenol A dimethacrylate) monomers; poly(vinyl acetate); poly(vinyl alcohol); poly(vinyl chloride); poly(vinylidene chloride); polyolefins, such as polyethylene and polypropylene; polyurethanes; polythiourethanes monomers, which include, but are not limited to materials such as the MR-6, MR-7, MR-8 and MR-10 optical resins sold by Mitsui Chemicals, Inc; thermoplastic polycarbonates, such as the thermoplastic bisphenol A-based polycarbonates, e.g., a carbonate-linked resin derived from bisphenol A and phosgene, one such material being sold under the trademark LEXAN; polyesters, such as the material sold under the trademark MYLAR; poly(ethylene terephthalate); polyvinyl butyral; poly(methyl methacrylate), such as the material sold under the trademark PLEXIGLAS, and polymers prepared by reacting polyfunctional isocyanate(s) with polythiol(s) or polyepisulfide monomers (such as the monomer sold under the trade name IU-10 by Mitsubishi Gas Chemicals, Inc.), either homopolymerized or co-and/or terpolymerized with polythiols, polyisocyanates, polyisothiocyanates and optionally ethylenically unsaturated monomers or halogenated aromatic-containing vinyl monomers.

In one non-limiting embodiment, the substrate is glass, ceramic or polymeric organic material and is an optical element, e.g., piano and vision correcting ophthalmic lenses, windows, clear polymeric films, automotive transparencies, e.g., windshields, aircraft transparencies, plastic sheeting, etc. In another non-limiting embodiment of the present invention the substrate is a polymeric organic material such as optically clear polymerizates, e.g., materials suitable for optical applications, such as optical elements. Such optically clear polymerizates may have a refractive index that may vary widely. In a still further non-limiting embodiment, application of the ungelled coating composition of the present invention to a polymeric film in the form of an “applique” may be accomplished using the methods describe in column 17, line 28 to column 18, line 57 of U.S. Pat. No. 5,198,267, which disclosure of the “applique” application method is incorporated herein by reference.

In a further non-limiting embodiment, the surface of the substrate to be coated may be treated prior to applying the ungelled coating composition for the purposes of cleaning the surface and promoting adhesion. Non-limiting examples of effective treatment techniques for substrates vary according to the nature of the substrate surface and are known to those skilled in the art. Various methods for treating the surface of different substrates are disclosed in U.S. Pat. No. 6,352,747 at column 5, line 34 to column 6, line 4, which methods of surface preparation are incorporated herein by reference.

In a still further non-limiting embodiment, a primer may be applied to the surface of the substrate before application of the coating compositions of the present invention. The primer may serve as a barrier coating to prevent interaction of the coating ingredients with the substrate and vice versa, and/or as an adhesive layer to adhere the coating composition to the substrate. Application of the primer may be by any of the methods used in coating technology.

In another non-limiting embodiment, photochromic optical elements may be prepared by sequentially applying to an optical element a primer, the ungelled coating composition of the present invention and appropriate protective coating(s) and/or hardcoats known to those skilled in the art. Protective coatings can provide a transition in properties from one coating to another. Non-limiting examples of protective coatings such as an acrylate-based film coherently appended to a photochromic coating are described in U.S. Patent Application Publication 2003/0165686 in paragraphs [0010] to [0023] and [0079] to [0173], which disclosure of acrylate-based films is incorporated herein by reference. Hardcoats which are also known as silicone-based hardcoats are well known in the art. Non-limiting disclosure of such hardcoats is found in U.S. Pat. Nos. 4,756,973 at column 5, lines 1-45 and 5,462,806 at column 1, lines 58 to column 2, line 8, and column 3, line 52 to column 5, line 50, which disclosures describing hardcoats are incorporated herein by reference.

Other coatings or surface treatments, e.g., a tintable coating, antireflective surface, hydrophobic coating, polarizing treatments, etc., in one non-limiting-embodiment, may also be applied to the cured coating of the present invention. In another non-limiting embodiment a further coating or treatment such as tintable coatings, antireflective coatings, hydrophobic coatings and polarizing treatments may be connected to at least a portion of a surface of the substrate, e.g., applied directly to the substrate on the uncoated surface of a lens or applied to a coating on either or both surfaces of the lens. As used herein the term “connecting to” means in direct contact with an object or indirect contact with an object through other structures or materials, one of which is in direct contact with the object.

There are a wide variety of methods that may be used to produce the photochromic articles of the present invention. In one non-limiting embodiment, the methods that may be used include those employed in factories for the mass production of articles and the methods used in non-factory settings, such as for the custom manufacture of photochromic coated lenses in an optical laboratory as known to those skilled in the art. A non-limiting example of a factory method is disclosed in U.S. Pat. No. 6,387,441 at column 2, line 27 to column 13, line 42, which disclosure of a method and apparatus for the batch, continuous or semi-continuous coating of optical lenses is incorporated herein by reference. A non-limiting example of a non-factory method is disclosed in U.S. Pat. No. 6,326,054 at column 1, line 64 to column 25, line 23, which disclosure to a process and machine for coating the surface of an ophthalmic lens within an enclosure is incorporated herein by reference.

In a further non-limiting embodiment, a method of the present invention comprises obtaining a substrate, connecting to a surface of the substrate an at least partial coating of any of the aforementioned ungelled coating compositions and at least partially curing the ungelled coating composition. The phrase “an at least partial coating” refers to a coating that covers from some to all of the surface. The phrase “at least partially curing the coating” refers to a coating of which from some to all of the curable components of the coating are cured, e.g., reacted or polymerized.

In a still further non-limiting embodiment, a method of the present invention for making a photochromic coated lens in a non-factory setting, e.g., an optical laboratory, comprises obtaining a lens coating apparatus; obtaining a lens; introducing the lens to the lens coating apparatus; connecting to a surface of the lens an at least partial coating of the aforementioned ungelled coating compositions; and at least partially curing the ungelled coating composition. In another non-limiting embodiment, the lens coating apparatus provides a controlled environment that prevents dirt or other forms of contamination into the process and controls the temperature and humidity of the environment.

The substrate, in one non-limiting embodiment, may be obtained as a preformed commercially available article to which the coating is applied, e.g., a glass and or plastic lens, or the substrate may be produced in a process, e.g., a cast lens, immediately preceding the coating application. In another non-limiting embodiment, the preformed and/or cast lens may be subjected to surfacing and/or machining processes, e.g., front and/or rear surfacing and edging, to adjust the lens to the desired prescription and/or to the size of the intended frames before and/or after the coating application.

After obtaining a substrate, any of the aforementioned ungelled coating compositions may be connected to a surface of the substrate. Non-limiting examples of coating methods used in coating technology include spray coating, spin coating, spread coating, curtain coating, dip coating, casting and roll-coating. In one non-limiting embodiment, the coating composition may be applied by spin coating, curtain coating, dip coating, spray coating methods, the spin and spray coating process disclosed in U.S. Pat. No. 6,352,747 at column 2, line 27 to column 11, line 16, which methods related to the coating of curved surfaces using the spin and spray coating process are incorporated herein be reference or by methods used in preparing overlays. Non-limiting methods for producing overlays are disclosed in U.S. Pat. No. 6,025,026 at column 15, line 45 to column 16, line 15, which disclosure for producing overlays is incorporated herein by reference.

In a further non-limiting embodiment, the thickness of the applied coating may vary widely. In one non-limiting embodiment, the applied and cured coating may have a thickness of from 1 to 1,000 microns. In another non-limiting embodiment, the coating thickness may be from 5 to 500 microns. In a further non-limiting embodiment, the coating thickness may be from 10 to 200 microns, e.g., 20 microns.

In accordance with a further non-limiting embodiment, following application of any of the aforementioned coating compositions to the treated or untreated surface of the substrate, the coating is at least partially cured. Depending on the substrate and components selected for the coating composition, the coating may be cured by a wide variety of methods.

Non-limiting methods for polymerizing the ungelled coating composition include irradiating the coating with infrared, ultraviolet, visible, thermal, microwave, gamma and electron radiation or a mixture thereof so as to initiate the polymerization reaction of the polymerizable precursor materials in the coating. According to one non-limiting embodiment, the precursor materials are polymerized in the presence of the photochromic materials. In another non-limiting embodiment, the precursor materials for the first polymer polymerizable by free-radical polymerization are polymerized in the presence of the photochromic materials.

In one non-limiting embodiment, when the ungelled coating composition comprises a photochromic material, precursor materials for a first polymer polymerizable by free-radical initiated polymerization and precursor materials for a second or additional polymer(s), the precursor materials for the first polymer may be at least partially cured by photo-initiated and/or thermally initiated polymerization and the precursor materials for the second or additional polymer(s) may be at least partially cured by photo-initiated and/or thermally initiated polymerization. In a further non-limiting embodiment, the at least partial curing of the precursor materials for the first polymer polymerizable by free-radical initiated polymerization is started before the at least partial curing of the precursor materials for the second or additional polymer(s) provided that the at least partial cure of the precursor materials for the second or additional polymer(s) is commenced prior to completion of the cure of precursor materials of the first polymer.

In a further non-limiting embodiment, the precursor materials for the first polymer, are at least partially cured by exposure to actinic radiation and/or thermal radiation to produce an at least partially tack free coated surface. The phrase “an at least partially tack free coated surface” refers to a coating having a surface that ranges from tacky or somewhat sticky to the touch to tack free. A tack free coating is not sticky to the touch and typically is not permanently damaged by a thumb print or by a cleaning process described hereinbefore for cleaning the surface of a substrate.

The ungelled coating compositions of the present invention may be at least partially cured by irradiating the composition with an initiating amount of radiation and/or adding to the composition an initiating amount of material e.g., an initiator described hereinbefore, capable of enabling polymerization to occur by free radical polymerization, and other methods such as thermal polymerization, photopolymerization or a combination thereof. Methods for polymerizing the precursor materials used to prepare the ungelled coating compositions of the present invention are well known to the skilled artisan and any of those well known techniques can be used.

In one non-limiting embodiment, photo-initiating radiation, e.g., ultraviolet radiation, and/or temperatures ranging from 22° C. to 200° C. may be used. If heating is required to obtain a cured coating, in one non-limiting embodiment, temperatures may be used below those at which the substrate would be damaged due to heating, e.g., 80° C. to 200° C. For example, typical organic polymeric materials may be heated up to 130° C. for a period of 1 to 16 hours in order to cure the coating without causing damage to the substrate. While a range of temperatures has been described for thermal curing of the coated substrate, it will be recognized by persons skilled in the art that temperatures other than those disclosed herein may be used.

In another non-limiting embodiment of the present invention, the curing process may be performed to simultaneously or sequentially cure the precursor materials for the at least two different polymers by using the methods known in the art for polymerizing or curing such precursor materials. In a further non-limiting embodiment, the ungelled coating composition of the present invention when polymerized or cured, forms a polymer network that is not dispersible in solvent.

According to George Odian in Principles of Polymer Synthesis, third edition, John Wiley & Sons, Inc. 1991, page 150, “The interpenetrating polymer network (IPN) is a blend of two different polymer networks without covalent bonds between the networks.” The resulting blend of different polymers is an intimate mixture of polymers held together by entanglements-produced during polymerization.

An IPN may be produced by the simultaneous or sequential polymerization of the two or more different groups of precursor materials for the two or more different polymers in the ungelled coating composition of the present invention. In one non-limiting embodiment, when an IPN is formed by simultaneous polymerization, a mixture of the precursor materials for the different polymers is at least partially polymerized at the same time. In another non-limiting embodiment, when an IPN is formed by sequential polymerization, the precursor materials for the first polymer are at least partially polymerized prior to the precursor materials for the second or additional polymer(s) provided that the at least partial polymerization of the precursor materials for the second or additional polymer(s) is commenced prior to completion of the polymerization of the precursor materials for the first polymer. Methods for the preparation of interpenetrating polymer networks are known to those skilled in the art of polymerization.

In an alternate non-limiting embodiment of the present invention, the ungelled coating composition comprises precursor materials for two or more different polymers that may upon at least partial curing in simultaneous or sequential polymerization processes form a crosslinked polymer network having covalent bonds between the different polymers. Methods for the preparation of polymer networks having covalent bonds between different polymers are known to those skilled in the art of polymerization. In one non-limiting embodiment, the use of precursor materials that form a polymer having residual functional groups that are adapted to be reactive with another polymer will promote the formation of covalent bonds between the different polymers.

In accordance with one non-limiting embodiment, the present invention includes a photochromic article, e.g., a photochromic optical element, such as a photochromic coated lens, produced by any of the methods described herein. In another non-limiting embodiment, it is desirable that the resulting photochromic article, e.g., a coated optical element, meets commercially acceptable “cosmetic” standards for optical coatings as known to those skilled in the art. In a further non-limiting embodiment, the cured coating of the present invention is substantially free of visually detectable cosmetic defects. Non-limiting examples of cosmetic defects of a coated lens include pits, spots, inclusions, cracks, hazing and crazing of the coating.

The present invention is more particularly described in the following examples, which are intended as illustrative only, since numerous modifications and variations therein will be apparent to those skilled in the art.

The following Compositions A-F are the various materials and precursor materials used to prepare the ungelled coating compositions of Examples 1-3 and the Comparative Example. Example 1 comprises a photochromic material and precursor materials for a polymethacrylate first polymer and a polyurethane second polymer. Examples 2 and 3 each have precursor materials for a different second polymer chosen from aminoplast-containing polymer and polyepoxide, respectively. The Comparative Example comprises photochromic material and precursor materials for only the polymethacrylate first polymer. Example 4 describes the preparation of lenses coated with the ungelled coating compositions of Examples 1-3 and the Comparative Example and the results of the testing of those lenses.

Composition A—Photochromic Material and Photoinitiators

The following materials were added in the order described to a suitable vessel equipped with an agitator.

| Material | Weight (grams) |
|---|---|
| 1-Methyl-2-pyrrolidinone | 15.4 |
| Photochromic 1⁽¹⁾ | 7.9 |
| Diphenyl (2,4,6-trimethylbenzoyl) | 0.3 |
| phosphineoxide | |
| Bis(2,4,6-trimethylbenzoyl)- | 0.2 |
| phenylphosphineoxide | |

⁽¹⁾A photochromic naphtho[1,2-b] pyran that exhibits a blue color when irradiated with ultraviolet light.

After all of the materials were added to the vessel, the agitator was turned on and mixed for two hours while heating to 50-60° C.

Composition B—Precursor Materials for a Polymethacrylate

The procedure used for Composition A was followed with the materials listed below:

| Material | Weight (grams) |
|---|---|
| Triethyleneglycol dimethacrylate | 45.5 |
| 30 Ethoxylated bisphenol A | 45.1 |
| dimethacrylate | |
| Trimethylolpropane trimethacrylate | 10.0 |

Composition C—Precursor Materials for a Polyurethane

The procedure used for Composition A was followed with the materials listed below:

| Material | Weight (grams) |
|---|---|
| PC1122⁽²⁾ | 9.9 |
| Poly(meth)acrylic Polyol | 5.2 |
| DESMODUR ® VP LS 2252⁽⁴⁾ | 10.0 |
| Dibutyltin dilaurate | 0.3 |

⁽²⁾An aliphatic polycarbonate diol available from Stahl, USA.
⁽³⁾A polyol produced by following the procedure of Composition D of Example 1 in U.S. Pat. No. 6,187,444, which procedure is incorporated herein by reference, except that in Charge 2, the styrene was replaced with methyl methacrylate and 0.5% by weight, based on the total monomer weight, of triphenyl phosphite was added.
⁽⁴⁾A blocked isophorone diisocyanate trimer available from Bayer, USA.

Composition D—Precursor Materials for an Aminoplast-containing Polymer

The procedure used for Composition A was followed with the materials listed below:

| Material | Weight (grams) |
|---|---|
| CYMEL ® 370⁽⁵⁾ | 14.3 |
| Poly(meth)acrylic polyol⁽³⁾ | 6.3 |
| NACURE ® 4167⁽⁶⁾ | 0.6 |

⁽⁵⁾A partially methylated melamine formaldehyde resin which is commercially available from Cytec.
⁽⁶⁾An acid phosphate catalyst which is commercially available from King Industries.

Composition E—Materials for a Polyacid Acid Curing Agent

The procedure used to prepare Composition F at column 22, line 44 to column 23, line 11 of U.S. Pat. No. 6,268,055, which procedure is incorporated herein by reference, was followed except with the weights of materials listed below:

| Material | Weight (grams) |
|---|---|
| 4-Methylhexahydrophthalic anhydride | 82.9 |
| Pentaerythritol | 17.1 |
| N-propyl alcohol | 51.1 |
| N-amyl propionate | 49.9 |

Composition F—Precursor Materials for a Polyepoxide

The procedure used for Composition A was followed with the materials listed below:

| Material | Weight (grams) |
|---|---|
| UVACURE ® 1502⁽⁷⁾ | 8.0 |
| Composition E | 17.3 |

⁽⁷⁾A cycloaliphatic epoxy which is available from UCB Chemicals.

### EXAMPLE 1

### An Ungelled Coating Composition of Photochromic Material and Precursor Materials for a Polymethacrylate and Polyurethane

The procedure used for Composition A was followed with the materials listed below:

| Material | Weight (grams) |
|---|---|
| Composition C | 10.7 |
| Composition A | 3.7 |
| Composition B | 7.6 |

### EXAMPLE 2

### An Ungelled Coating Composition of Photochromic Material and Precursor Materials for a Polymethacrylate and an Aminoplast-Containing Polymer

The procedure used for Composition A was followed with the materials listed below:

| Material | Weight (grams) |
|---|---|
| Composition D | 8.3 |
| Composition A | 3.8 |
| Composition B | 7.6 |

### EXAMPLE 3

### An Ungelled Coating Composition of Photochromic Material and Precursor Materials for a Polymethacrylate and Polyepoxide

The procedure used for Composition A was followed with the materials listed below:

| Material | Weight (grams) |
|---|---|
| Composition F | 9.7 |
| Composition A | 3.6 |
| Composition D | 7.6 |

### COMPARATIVE EXAMPLE

### A Coating Composition of Photochromic Material and Precursor Materials for a Polymethacrylate

The procedure used for Composition A was followed with the materials listed below:

| Material | Weight (grams) |
|---|---|
| Composition B | 15.3 |
| Composition A | 3.6 |

### EXAMPLE 4

The preparation of the lenses is described in Part A; the coating of the lenses is described in Part B; the Adhesion Testing of the Coated Lenses is described in Part C; Microhardness Testing of Coated Lenses with a FISCHERSCOPE® instrument is described in Part D; and the Photochromic Performance Testing of the Coated Lenses is described in Part E.

### Part A

Plano lenses prepared from CR-39® monomer having a diameter of 72 millimeters were washed with dishwashing detergent and water, rinsed with the deionized water and dried. The lenses were treated with oxygen plasma at a flow rate of 100 milliliters (mL) per minute of oxygen at 100 watts of power for one minute.

### Part B

The lenses prepared in Part A were coated with the solutions of Examples 1-3 and the Comparative Example via a spin coating process. About 1-2 mL of the solution of each example was dispensed onto the lens and the lens rotated at 1,500 rpm for the times listed in Table 1 to provide a wet coating having a weight of about 0.19 grams.

The coated lenses were cured by exposure to ultraviolet radiation in an atmosphere having less than 100 ppm of oxygen in an EYE® Ultraviolet Conveyor line traveling 70 centimeters per minute beneath two 400 watt/inch “V” type bulbs, one positioned 3.5 inches above the conveyor and the other positioned 7.0 inches above the conveyor. After the ultraviolet cure, the coated lenses of Examples 1 and 2 were placed in a 120° C. oven for one hour and the coated lenses of Example 3 were placed in a 140° C. oven for one hour. Four coated lenses were prepared for each example. Two of the lenses were used for adhesion testing. The other two were first tested for microhardness with the FISCHERSCOPE® instrument and then Photochromic Performance.

TABLE 1
Spin Coating Parameters

| | Spin Time |
|---|---|
| Example No. | (seconds) |
| 1 | 6.0 |
| 2 | 7.0 |
| 3 | 7.0 |
| Comparative | 2.5 |

### Part C

The adhesion of the coated lenses was tested using a procedure which is a modification of ASTM D-3539 Standard Test Method for Measuring Adhesion by Tape Test—Method B. The standard method was modified to include retesting of a different site on the same sample tested for Dry Adhesion after the sample was held in boiling water for an hour after which the Wet Adhesion Test was done. Results are reported as Percent Remaining after testing. Typically, if the sample failed the Dry Adhesion Test, it was not subjected to the Wet Adhesion Test. The tape used was 3M® #600 clear tape. Results are listed in Table 2 for duplicate samples labeled A or B for each example.

TABLE 2

| Example | Percent Remaining | Percent Remaining |
|---|---|---|
| Number | In Dry Adhesion Test | In Wet Adhesion Test |
| 1A | 100 | 100 |
| 1B | 100 | 100 |
| 2A | 80 | 100 |
| 2B | 95 | 100 |
| 3A | 100 | 100 |
| 3B | 100 | 100 |
| CEA | 0 | — |
| CEB | 0 | — |

The results of Table 2 showed that the coated lenses of the Comparative Example demonstrated 0% adhesion while the coated lenses of Examples 1, 2 and 3 showed at least 80% or higher adhesion in the Dry Adhesion Test and 100% in the Wet Adhesion Test.

### Part D

The coated lenses prepared in Part B were subjected to microhardness testing using a FISCHERSCOPE® HCV, Model H-100 instrument available from Fis'dianek4448@comcast.net'cher Technology, Inc. The microhardness is measured in Newtons per mm². Each lens was measured from 2 to 5 times and the resulting data was averaged. The hardness measurements were taken as the hardness at a penetration depth of 2 microns after a 100 Newton load for 15 seconds. The arithmetic average of the results of the two lenses are listed in Table 3.

TABLE 3

| | Microhardness |
|---|---|
| Example No. | (Newton/mm²) |
| 1 | 45 |
| 2 | 47 |
| 3 | 77 |
| CE | 42 |

The results of Table 3 showed that the coated lenses of Examples 1, 2 and 3 had higher microhardness results than the coated lenses of the Comparative Example.

### Part E

The photochromic performance of each of the aforementioned coating compositions was performed as follows. The coated lenses prepared above were tested for photochromic response on the Bench for Measuring Photochromics (“BMP”) optical bench made by Essilor, Ltd. France. The optical bench was maintained at a constant temperature of 73.4° F. (23° C.) during testing.

Prior to testing on the optical bench, each of the coated lenses were exposed to 365-nanometer ultraviolet light for about 10 minutes at a distance of about 14 centimeters to activate the photochromic materials. The UVA (315 to 380 nm) irradiance at the lens was measured with a LICOR® Model Li-1800 spectroradiometer and found to be 22.2 watts per square meter. The lens was then placed under a 500 watt, high intensity halogen lamp for about 10 minutes at a distance of about 36 centimeters to bleach (inactivate) the photochromic materials. The illuminance at the lens was measured with the LICOR® spectroradiometer and found to be 21.4 Klux. The lenses were then kept in a dark environment at room temperature (from 70 to 75° F., or 21 to 24° C.) for at least 1 hour prior to testing on an optical bench. Prior to optical bench measurement, the lenses were measured for ultraviolet absorbance at 390 nanometers.

The BMP optical bench was fitted with two 150-watt ORIEL® Model #66057 Xenon arc lamps at right angles to each other. The light path from Lamp 1 was directed through a 3 mm SCHOTT® KG-2 band-pass filter and appropriate neutral density filters that contributed to the required UV and partial visible light irradiance level. The light path from Lamp 2 was directed through a 3 mm SCHOTT® KG-2 band-pass filter, a SCHOTT® short band 400 nm cutoff filter and appropriate neutral density filters in order to provide supplemental visible light illuminance. A 2 inch×2 inch 50% polka dot beam splitter, at 45° to each lamp is used to mix the two beams. The combination of neutral density filters and voltage control of the Xenon arc lamp were used to adjust the intensity of the irradiance. Proprietary software was used on the BMP to control timing, irradiance, air cell and sample temperature, shuttering, filter selection and response measurement. A ZEISS® spectrophotometer, Model MCS 501, with fiber optic cables for light delivery through the lens was used for response and color measurement. Photopic response measurements, as well as the response at four select wavelengths, were collected on each lens.

The power output of the optical bench, i.e., the dosage of light that the lens was exposed to, was adjusted to 6.7 Watts per square meter (W/m²) UVA, integrated from 315-380 nm and 50 Klux illuminance, integrated from 380-780 nm. Measurement of the power output was made using the optometer and software contained within the BMP.

Response measurements, in terms of a change in optical density (ΔOD) from the unactivated or bleached state to the activated or colored state were determined by establishing the initial unactivated transmittance, opening the shutter from the Xenon lamp(s) and measuring the transmittance through activation at selected intervals of time. Change in optical density was determined according to the formula: ΔOD=log (10)(% Tb/% Ta), where % Tb is the percent transmittance in the bleached state, % Ta is the percent transmittance in the activated state. Optical density measurements were based on photopic optical density.

The results of this testing are presented below in Table 4, wherein the ΔOD is after 15 minutes of activation and the First Fade Half Life (“T½”) value is the time interval in seconds for the ΔOD of the activated form of the photochromic material in the coating to reach one half the fifteen-minute ΔOD at 73.4° F. (23° C.), after removal of the activating light source.

TABLE 4

| | ΔOD after | |
|---|---|---|
| | 15 | First Half-life |
| Example # | minutes | of fade (sec) |
| 1 | 0.62 | 57 |
| 2 | 0.63 | 91 |
| 3 | 0.65 | 191 |
| CE | 0.63 | 44 |

The results of Table 4 showed that the coated lenses of Examples 1, 2 and 3 when compared to the coated lenses of the Comparative Example demonstrated comparable ΔOD levels after 15 minutes and longer time intervals for the first half life of fade.

Although the present invention has been described with reference to the specific details of particular embodiments thereof, it is not intended that such details be regarded as limitations upon the scope of the invention except as and to the extent that they are included in the accompanying claims.

We claim:

1. An ungelled coating composition comprising a photochromic material, precursor materials for a first polymer polymerizable by free-radical initiated polymerization and precursor materials for a second polymer selected from polyurethane, poly(urea-urethane) and mixtures thereof, the precursor materials for said second polymer comprising at least one blocked polyisocyanate.

2. The ungelled coating composition of claim 1 wherein said precursor materials for the first polymer comprise ethylenically unsaturated groups.

3. The ungelled coating composition of claim 2 wherein said unsaturated groups are selected from allylic groups, methacrylic groups, acrylic groups, vinyl groups and mixtures thereof.

4. The ungelled coating composition of claim 1 wherein said blocked polyisocyanate is essentially free of unblocked isocyanate groups.

5. The ungelled coating composition of claim 4 wherein said blocked polyisocyanate is selected from: aliphatic polyisocyanates; aromatic polyisocyanates; cycloaliphatic polyisocyanates; heterocyclic polyisocyanates; derivatives thereof and mixtures thereof.

6. The ungelled coating composition of claim 5 wherein said aliphatic polyisocyanates are selected from: tetramethylene-1,4-diisocyanate; hexamethylene-1,6-diisocyanate; 2,2,4-trimethyl hexane-1,6-diisocyanate; lysine methyl ester diisocyanate; bis (isocyanato ethyl)fumarate; ethylene diisocyanate; dodecane-1,12-diisocyanate; derivatives thereof and mixtures thereof; said aromatic polyisocyanates are selected from: toluene-2,4-diisocyanate; toluene-2,6-diisocyanate; diphenyl methane -4,4′-diisocyanate; diphenyl methane-2,4′-diisocyanate; para-phenylene diisocyanate; biphenyl diisocyanate; 3,3′-dimethyl-4,4′-diphenylene diisocyanate; derivatives thereof and mixtures thereof; said cycloaliphatic polyisocyanates are selected from: isophorone diisocyanate; cyclobutane-1,3-diisocyanate; cyclohexane-1-3-diisocyanate; cyclohexane-1,4-diisocyanate; methyl cyclohexyl diisocyanate; perhydrodiphenylmethane-2,4′-diisocyanate; perhydrodiphenylmethane-4,4′-diisocyanate, derivatives thereof and mixtures thereof.

7. The ungelled coating composition of claim 6 wherein the blocking agent of said blocked polyisocyanate is volatile alcohol selected from: methanol and diisopropyl amine; epsilon-caprolactam; azole-containing material selected from 1,2,4-triazole and 3,5-dimethyl pyrazole; methyl ethyl ketoxime; and mixtures thereof.

8. The ungelled coating composition of claim 1 wherein when the second polymer is polyurethane, the precursor materials further comprise a polyol and when the second polymer is poly(urea-urethane), the precursor materials further comprise a polyamine and a polyol.

9. The ungelled coating composition of claim 8 wherein the polyamine comprises an aliphatic polyamine, aromatic polyamine and mixtures thereof.

10. The ungelled coating composition of claim 9 wherein each of the polyol precursor materials for the second polymer are independently selected from: low molecular weight polyols; polyester polyols; polyether polyols; amide-containing polyols; polyacrylic polyols; epoxy polyols; polyhydric polyvinyl alcohols; polycarbonate polyols; urethane polyols; and mixtures thereof.

11. The ungelled coating composition of claim 10 wherein each of the precursor materials for the second polymer independently further comprise a catalyst selected from: tin octylate; dibutyltin diacetate; dibutyltin dilaurate; dibutyltin mercaptide; dibutyltin dimaleate; dimethyltin diacetate; dimethyltin dilaurate; dimethyltin mercaptide; dimethyltin dimaleate; triphenyltin acetate; triphenyltin hydroxide; 1,4-diazabicyclo[2.2.2]octane; triethylamine; bismuth carboxylate and mixtures thereof.

12. The ungelled coating composition of claim 1 wherein the photochromic material is selected from inorganic photochromic materials, organic photochromic materials and mixtures thereof.

13. The ungelled coating composition of claim 12 wherein said organic photochromic material is selected from pyrans, oxazines, fulgides, fulgimides, diarylethenes and mixtures thereof.

14. The ungelled coating composition of claim 13 wherein said organic photochromic material is adapted to polymerize with the precursor materials for the first polymer and/or with the precursor materials for the second polymer.

15. An ungelled coating composition comprising a photochromic material, precursor materials for a first polymer polymerizable by free-radical initiated polymerization and precursor materials for one or more additional polymer(s) different from the first polymer, said ungelled coating composition being substantially free of polyurethanes and/or poly(urea-urethanes).

16. The ungelled coating composition of claim 15 wherein said ungelled coating composition is essentially free of polyisocyanates.

17. The ungelled coating composition of claim 16 wherein the additional polymer(s) is selected from: polyepoxides; polyoxetanes; aminoplast-containing polymers, tris(alkoxycarbonylamino)triazine-containing polymers, polyanhydride-containing polymers; polyacrylamide-containing polymers; polyethers; (meth)acrylic addition interpolymers; organopolysiloxanes; and mixtures thereof.

18. A method of making a photochromic coated article comprising:
a) obtaining a substrate;
b) connecting to a surface of said substrate an at least partial coating of an ungelled coating composition comprising a photochromic material, precursor materials for a first polymer polymerizable by free-radical initiated polymerization and precursor materials for a second polymer selected from polyurethane, poly(urea-urethane) and mixtures thereof, said precursors for the second polymer comprising at least one blocked polyisocyanate; and
c) at least partially curing the coating of said ungelled coating composition.

19. The method of claim 18 wherein the ungelled coating composition of (b) comprises a photochromic material, precursor materials for a first polymer polymerizable by free-radical initiated polymerization and precursor materials for one or more additional polymer(s) different from the first polymer, said ungelled coating composition being substantially free of polyurethanes and/or poly(urea-urethanes).

20. The method of claim 18 wherein said substrate is a material selected from: glass; ceramic; and polymeric organic material.

21. The method of claim 20 wherein the substrate is an optical element.

22. The method of claim 18 wherein the at least partial curing of the coating of said ungelled coating composition is carried out such that an at least partial cure of the precursor materials for the second polymer is commenced prior to completion of cure of precursor materials for the first polymer.

23. The method of claim 19 wherein the at least partial curing of the coating of said ungelled coating composition is carried out such that an at least partial cure of the precursor materials for said one or more additional polymer(s) is commenced prior to completion of cure of precursor materials for the first polymer.

24. A photochromic coated article produced by the method of claim 18.

25. A method of making a photochromic coated lens comprising:
a) obtaining a lens coating apparatus;
b) obtaining a lens;
c) introducing said lens to the lens coating apparatus;
d) connecting to a surface of said lens an at least partial coating of an ungelled coating composition comprising a photochromic material, precursor materials for a first polymer polymerizable by free-radical initiated polymerization and precursor materials for a second polymer selected from polyurethane, poly(urea-urethane) and mixtures thereof, said precursor materials for the second polymer comprising at least one blocked polyisocyanate; and
e) at least partially curing the coating of said ungelled coating composition.

26. The method of claim 25 wherein the at least partial curing of the coating of said ungelled coating composition of (e) is carried out such that an at least partial cure of the precursor materials for the second polymer is commenced prior to completion of cure of precursor materials for the first polymer.

27. The method of claim 26 wherein the at least partial curing of the precursor materials for the first polymer is by exposure to actinic radiation and/or thermal radiation to produce an at least partially tack free coated surface.

28. A photochromic coated lens produced by the method of claim 25.
